(19) United States
(12) Patent Application Publication
(10) Pub. No.: US 2025/0119012 A1
(43) Pub. Date: Apr. 10, 2025

(54) Molded Rotor

(71) Applicant: East West Manufacturing, LLC, Atlanta, GA (US)

(72) Inventor: Stephen Andrew Semidey, Woodstock, GA (US)

(21) Appl. No.: 18/905,661

(22) Filed: Oct. 3, 2024

Related U.S. Application Data
(60) Provisional application No. 63/587,945, filed on Oct. 4, 2023.

(51) Int. Cl. H02K 1/2783; H02K 1/02; H02K 15/03

(52) U.S. Cl. CPC H02K 1/2783; H02K 1/02; H02K 15/03

(57) ABSTRACT

A molded internal permanent magnet rotor having a plurality of laminate sections disposed circumferentially around the rotor and a permanent magnetic plastic material injection molded between the laminate sections. The permanent magnetic plastic material forms radially extending portions disposed between the laminate sections and an internal ring portion located radially inward from the laminate sections. The permanent magnetic plastic material, once cured, engages retaining features in the laminate sections to restrict radial displacement.

### CROSS REFERENCE TO RELATED APPLICATION

This disclosed technology claims the benefit of U.S. Provisional Application Ser. No. 63/587,945 filed on Oct. 4, 2023. The contents of which are incorporated herein by reference in their entirety as if fully set forth below.

### FIELD

This disclosed technology relates to an internal permanent magnet rotor for an electronically commutated DC motor (EC motor) and more particularly to a molded rotor in which permanent magnet plastic material is injection molded into defined regions in the rotor and magnetized.

### BACKGROUND

Convention internal permanent magnetic rotors typically have wedge-shaped silicon steel laminate sections (laminate sections) disposed circumferentially around the rotor. The wedge-shape of the laminate sections allow for pole separation and focusing the magnetic flux. Permanent bar magnets are then typically positioned between each laminate section. To retain the laminate sections and the bar magnets in place, a non-conductive wrap (Kevlar or fiberglass) is typically wrapped around the rotor circumference, as disclosed in publication WO 2021/225902 entitled “Permanent Magnet Motor with Wrapping.”

Among the challenges and drawbacks associated with the convention internal permanent magnetic rotors is the reliance on high magnetic density permanent magnets, such as rare earth elements like neodymium, which can lead to higher costs to achieve performance targets. Furthermore, the extra steps of positioning and securing the bar magnets and wrapping the rotor may be difficult and expensive to manufacture.

There are still needs for improved rotor designs and manufacturing techniques that can utilize the benefits of an injection molded permanent magnet rotor while overcoming the challenges and expense associated with attaching magnets and wrapping the rotor to secure the associated components.

### BRIEF SUMMARY

The disclosed technology avoids the necessity of attaching bar magnets and wrapping a rotor by providing a molded rotor. In particular, the disclosed technology may utilize a permanent magnetic plastic material that can be injection-molded between laminate sections to form the magnetic segments of the molded rotor. In certain implementations, the injection-molded sections may be magnetized in-situ during manufacturing.

In accordance with certain exemplary implementations of the disclosed technology, the laminate sections have circumferentially extending retaining features that may engage the magnetic plastic material. Once the magnetic plastic material has cured and hardened, the engagement between the cured magnetic plastic material and the retaining features may retain the laminate sections in the molded rotor assembly, thereby eliminating the need for a wrap around the circumference of the molded rotor. Certain implementations may use one or more end plates to provide additional magnetic flux control and/or performance of the rotor.

In accordance with certain exemplary implementations of the disclosed technology, a molded internal permanent magnet rotor is provided that includes a plurality of laminate sections disposed circumferentially around the rotor, and a permanent magnetic plastic material injection molded between the laminate sections, wherein the permanent magnetic plastic material forms radially extending portions disposed between the laminate sections, and an internal ring portion located radially inward from the laminate sections. The permanent magnetic plastic material, once cured, engages the laminate sections to restrict radial displacement, eliminating the need for external wrapping or retainers.

In another aspect, a method of manufacturing is disclosed herein for making a molded internal permanent magnet rotor. The method includes disposing a plurality of laminate sections circumferentially around a central rotational axis and injection molding a permanent magnetic plastic material between the laminate sections. Injecting molding the permanent magnetic plastic material forms radially extending portions disposed between the laminate sections; and an internal ring portion located radially inward from the laminate sections, wherein the permanent magnetic plastic material, once cured, engages the laminate sections to restrict radial displacement. The method can further include selectively magnetizing the permanent magnetic plastic material.

These and other aspects of the disclosed technology are described below with the aid of the accompanying drawings. Other aspects and features of embodiments will become apparent to those of ordinary skill in the art upon reviewing the following description of specific, exemplary embodiments in concert with the drawings. While features of the disclosed technology may be discussed relative to certain embodiments and figures, all embodiments of the present disclosure can include one or more of the features discussed herein. Further, while one or more embodiments may be discussed as having certain advantageous features, one or more of such features may also be used with the various embodiments discussed herein. In similar fashion, while exemplary embodiments may be discussed below as device, system, or method embodiments, it is to be understood that such exemplary embodiments can be implemented in various devices, systems, and methods of the disclosed technology.

### BRIEF DESCRIPTION OF THE DRAWINGS

FIG. 1 is a perspective view of a first embodiment of a molded internal permanent magnet rotor for an EC motor in accordance with the disclosed technology.

FIG. 2 is a front elevation view of the first embodiment of the molded internal permanent magnet rotor for an EC motor in accordance with the disclosed technology.

FIG. 3 is a side elevation view of the first embodiment of the molded internal permanent magnet rotor for an EC motor in accordance with the disclosed technology.

FIG. 4 is a side elevation view of a second embodiment of a molded internal permanent magnet rotor for an EC motor in accordance with the disclosed technology.

FIG. 5 is a side elevation view of a third embodiment of a molded internal permanent magnet rotor for an EC motor in accordance with the disclosed technology.

FIG. 6A is a side elevation view of a fourth embodiment of a molded internal permanent magnet rotor for an EC motor in accordance with the disclosed technology, where the molded rotor and laminate section inset illustrations are included for clarity.

FIG. 6B is a side elevation view of a fifth embodiment of a molded internal permanent magnet rotor for an EC motor in accordance with the disclosed technology, where the molded rotor and laminate section inset illustrations are included for clarity.

FIG. 7A is a perspective view of a sixth embodiment of a molded internal permanent magnet rotor for an EC motor having one or more end plates, in accordance with the disclosed technology.

FIG. 7B is another perspective view of the sixth embodiment of a molded internal permanent magnet rotor for an EC motor having one or more end plates, in accordance with the disclosed technology.

FIG. 7C is a perspective view of the sixth embodiment of a molded internal permanent magnet rotor for an EC motor with one end plate and the molded rotor show transparently for clarity.

FIG. 7D is a side elevation view of the sixth embodiment of a molded internal permanent magnet rotor for an EC motor in accordance with the disclosed technology.

FIG. 8 is a partial side elevation view of an example in-situ magnetizing apparatus, in accordance with certain implementations of the disclosed technology.

FIG. 9 is side elevation view of a magnetized injection molded internal permanent magnet rotor array where the arrows indicate the magnetic field direction, accordance with the disclosed technology.

FIG. 10A is a perspective view of an example laminate section embodiment, in accordance with the disclosed technology.

FIG. 10B is a side elevation view of one of the example laminate sections disposed relative to the outer axial circumference of the rotor.

FIG. 10C is a side elevation view of the example laminate section embodiment as illustrated in FIG. 10A in accordance with the disclosed technology.

FIG. 11A is a perspective view of an example laminate section embodiment, in accordance with the disclosed technology.

FIG. 11B is a side elevation view of the example laminate section embodiment as illustrated in FIG. 11A in accordance with the disclosed technology.

FIG. 12 is a flow diagram of a method, in accordance with certain exemplary implementations of the disclosed technology.

### DETAILED DESCRIPTION

To facilitate an understanding of the principles and features of the disclosed technology, various illustrative embodiments are explained below. The components, steps, and materials described hereinafter as making up various elements of the embodiments disclosed herein are intended to be illustrative and not restrictive. Many suitable components, steps, and materials that would perform the same or similar functions as the components, steps, and materials described herein are intended to be embraced within the scope of the disclosure. Such other components, steps, and materials not described herein can include, but are not limited to, similar components or steps that are developed after development of the embodiments disclosed herein.

Certain implementations of the disclosed technology include simplified rotor designs that can reduce manufacturing costs. Certain implementations of the disclosed technology can be particularly well matched for use in electronically commutated DC motors (EC motors). Certain implementations of the disclosed technology may be utilized for axial-flux motors. In accordance with certain exemplary implementations of the disclosed technology, the disclosed technology may allow for the replacement of expensive permanent magnets with less expensive materials. Several example implementations of the molded internal permanent magnet rotor will now be discussed with reference to the following figures.

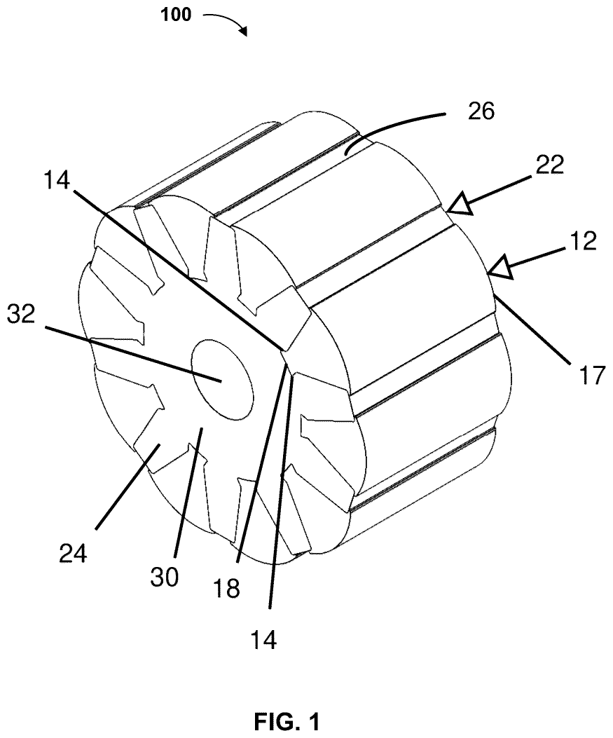

FIG. 1 depicts a perspective view of a first example implementation of a molded internal permanent magnet rotor 100 for an EC motor. In this implementation, the rotor 100 may include a plurality of wedge-shaped silicon steel laminate sections 12 disposed circumferentially around the molded rotor 100 and injection molded magnetic plastic material 22 with radially extending portions 24 disposed between the laminate sections 12 and extending inwardly to form an internal ring portion 30 of the rotor 100. In accordance with certain exemplary implementations of the disclosed technology, the laminate sections 12 have outer ends 17 and inner ends 18. The outer ends 17 of the laminate sections 12 may define an outer circumference of the molded rotor 100. As shown in FIG. 1, and in accordance with certain implementations of the disclosed technology, the outer ends 17 of the laminate sections 12 may be separated from each other by gaps 26. In certain implementations, the gaps 26 may provide an improved path for magnetic flux interaction with a corresponding stator (not shown).

In accordance with certain exemplary implementations of the disclosed technology, a permanent magnetic plastic material 22 may be injection molded between the laminate sections 12 to form a corresponding radially extending portions 24 and internal ring portion 30 of the molded rotor 100. A central opening 32 in the internal ring portion 30 may accommodate a shaft for rotation of the molded rotor 100.

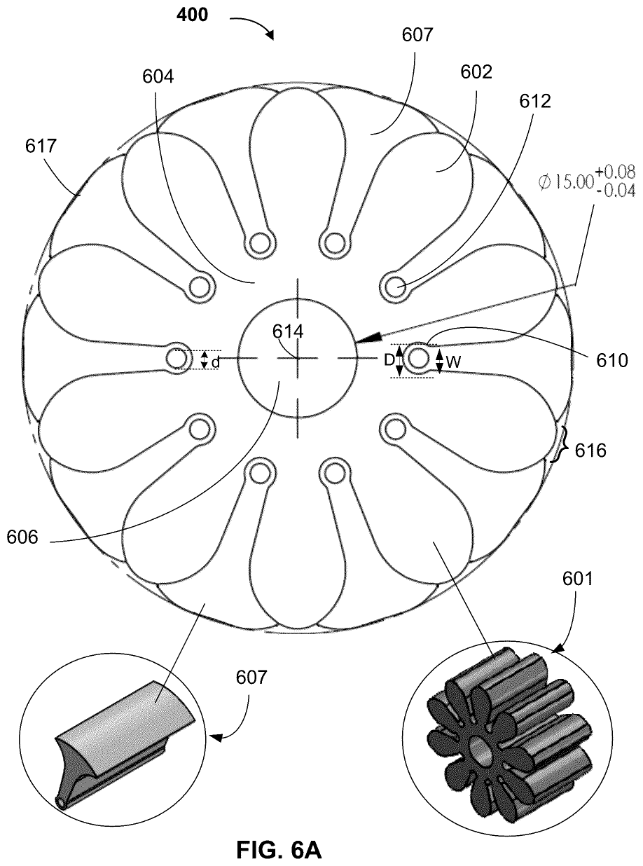

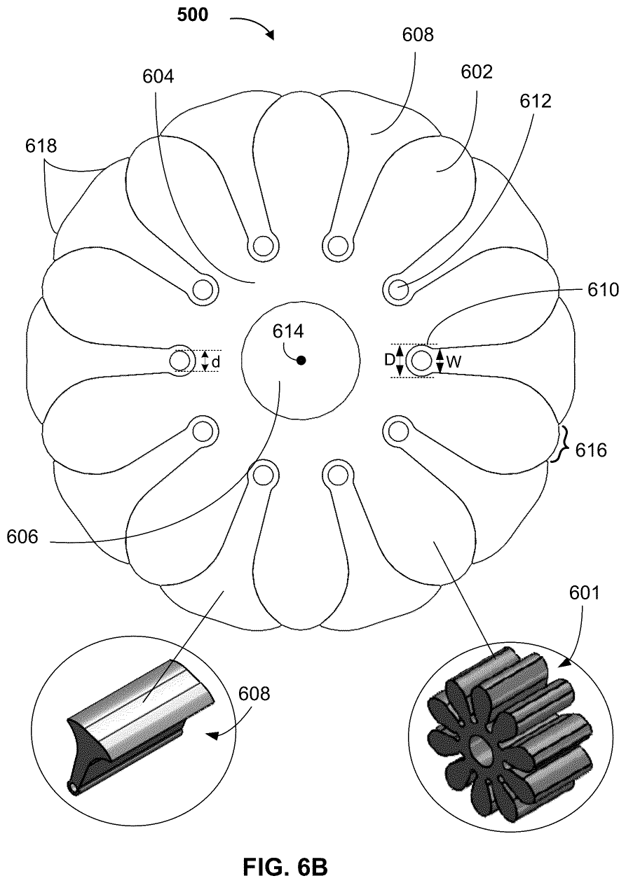

In accordance with certain exemplary implementations of the disclosed technology, each of the wedge-shaped laminate sections 12 may include retaining features 14 extending circumferentially from the inner ends 18 such that at least a portion of the retaining features 14 extend into the magnetic plastic material 22. Once the injected magnetic plastic material 22 has cured and hardened, the magnetic plastic material 22 may engage the retaining features 14 to retain the laminate sections 12 without the need for any external wrapping or additional retainer. In certain implementations, the retaining features 14 may be in the form of a dovetail shape, as illustrated in FIG. 1. In other implementations, as will be discussed below with respect to FIGS. 6-9, the retaining features may be implemented with other shapes that may engage with the injected magnetic plastic material 22 to secure the laminate sections to the rotor.

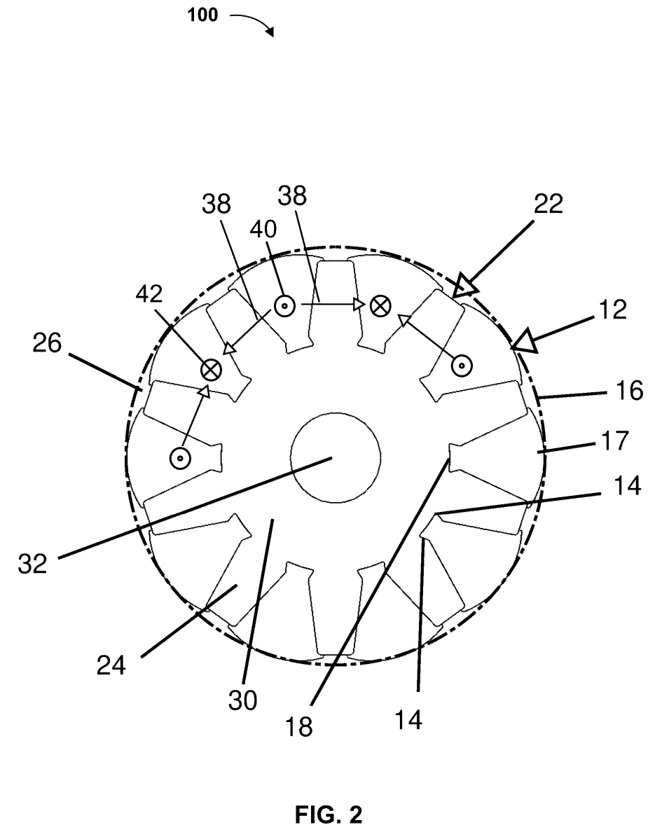

FIG. 2 is a front elevation view of the first example implementation of the molded internal permanent magnet rotor 100 for an EC motor in accordance with the disclosed technology, with most of the same element identification numerals as shown in FIG. 1. As illustrated in FIG. 2 and FIG. 1, the wedge-shaped laminate sections 12 may include retaining features 14 such as dovetail tabs, for example, that extend circumferentially from the inner ends 18 of the laminate sections 12 into the magnetic plastic material 22. Once the magnetic plastic material 22 has cured and hardened, the magnetic plastic material 22 engages the retaining features 14 to interlock with and retain the laminate sections 12 without the need for any external wrapping or retainer. In certain implementations, the outer ends 17 of laminate sections 12 may define an outer circumference 16 of the rotor 100.

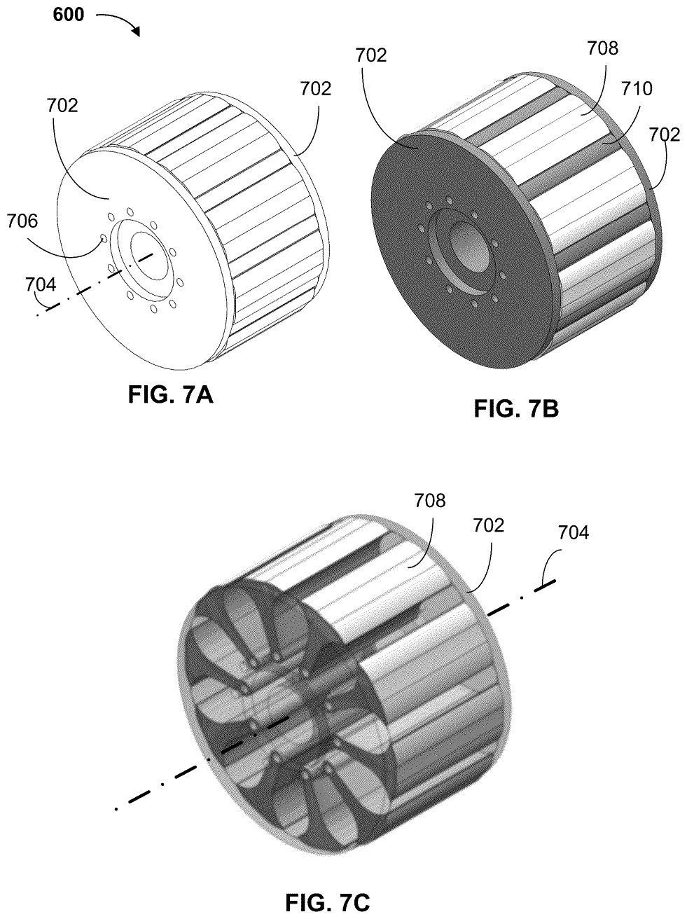

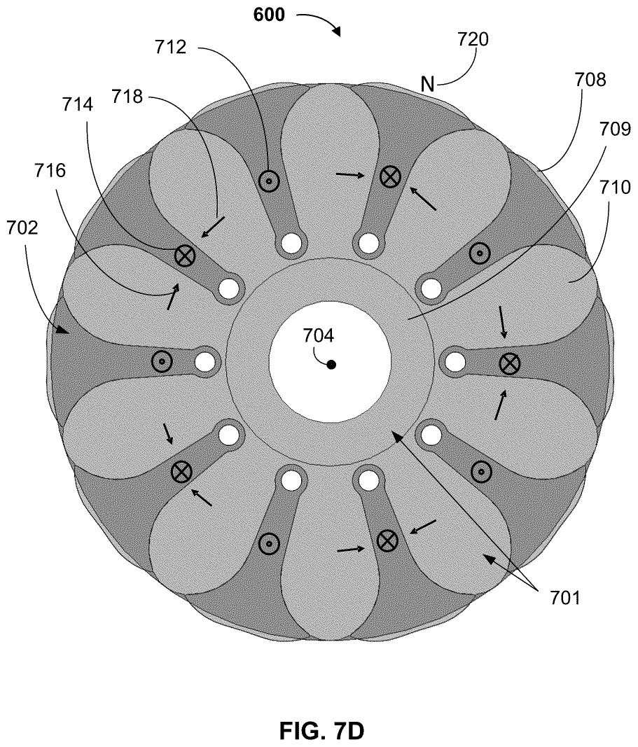

FIG. 2 also depicts superimposed arrows that illustrate the magnetization direction 38 resulting from an applied magnetic field having interdigitated north poles 40 and south poles 42. Certain implementations of the disclosed technology can include in-situ magnetization of the magnetic plastic material 22, as will be discussed below with reference to FIG. 7D.

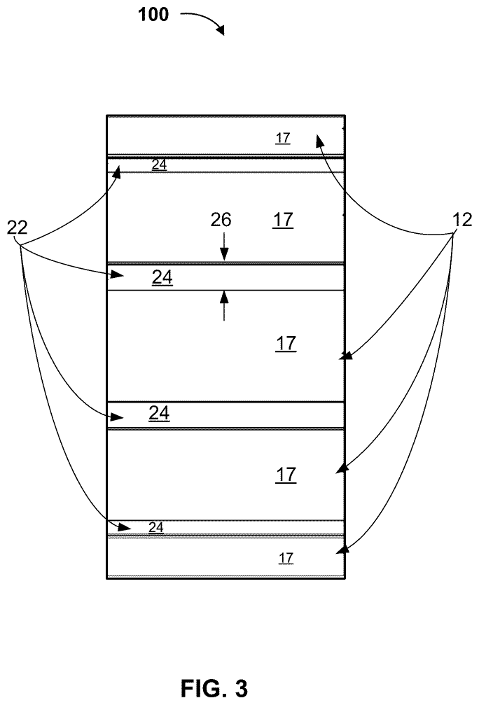

FIG. 3 is a side elevation view of the first embodiment of the molded internal permanent magnet rotor 100 for an EC motor in accordance with the disclosed technology. As illustrated, the outer portions 17 of the laminate sections 12 may be interdigitated with the radially extending outer portions 24 of the magnetic plastic material 22 such that the laminate sections 12 are separated from each other by gaps 26. In accordance with certain exemplary implementations of the disclosed technology, the gaps 26 between the laminate sections 12 may enable concentration of the magnetic fields in the gaps 26, for example, to avoid interference from laminate sections 12.

Table 1 lists properties of various magnetic plastic material 22 that may be suitable for use in the various implementation of the disclosed technology.

TABLE 1

| Material | Unit | Ferrite | Ferrite | Ferrite | NdFeB | NdFeB | NdFeB | NdFeB |
|---|---|---|---|---|---|---|---|---|
| Magnetic | | Anisotropic | Anisotropic | Anisotropic | Isotropic | Isotropic | Isotropic | Isotropic |
| properties | | | | | | | | |
| Residual flux | mT | 272 | 282 | 288 | 454 | 507 | 536 | 585 |
| density (Br) | Gs | 2720 | 2820 | 2880 | 4540 | 5070 | 5360 | 5850 |
| Coercive | KA/m | 195 | 187 | 187 | 305 | 338 | 353 | 370 |
| force (bHc) | Oe | 2450 | 2350 | 2350 | 3833 | 4247 | 4436 | 4650 |
| Intrinsic | KA/m | 235 | 227 | 227 | 691 | 693 | 773 | 710 |
| coercive | Oe | 2953 | 2853 | 2853 | 8683 | 8709 | 9714 | 8922 |
| force(iHc) | | | | | | | | |
| Maximum | KJ/m3 | 14.3 | 15.6 | 16.2 | 35 | 43 | 47 | 54.1 |
| energy | MGOe | 1.80 | 1.96 | 2.04 | 4.40 | 5.40 | 5.91 | 6.80 |
| product | | | | | | | | |
| (Bhmax) | | | | | | | | |
| Thermal | %0 C. | −0.19 | −0.19 | −0.19 | −0.19 | −0.19 | −0.19 | −0.19 |
| coefficient | | | | | | | | |
| (Br/Br) | | | | | | | | |
| Thermal | %0 C. | 0.25 | 0.25 | 0.25 | 0.25 | 0.25 | 0.25 | 0.25 |
| coefficient | | | | | | | | |
| (Hc/Hc) | | | | | | | | |
| Tensile | MPa | 58 | 57.6 | 45.5 | 62.5 | 59.7 | 62.9 | 60.3 |
| strength | | | | | | | | |
| Flexural | MPa | 103 | 106 | 90.6 | 118.3 | 115 | 121.4 | 114.3 |
| strength | | | | | | | | |
| Specific | g/cm3 | 3.52 | 3.64 | 3.69 | 4.69 | 5.01 | 5.02 | 5.28 |
| gravity | | | | | | | | |
| Molding | % | 0.7 | 0.7 | 0.65 | 0.6 | 0.4 | 0.5 | 0.4 |
| shrinkage | | | | | | | | |
| coefficient | | | | | | | | |
| Melt flow | g/10 min | 90 | 80 | 70 | 463 | 470 | 412 | 505 |
| rate | | | | | | | | |

| Applications | Automotive Motors Power Tools Household Appliances OA | Micromotors OA Facilities |
|---|---|---|
| | Facilities | |

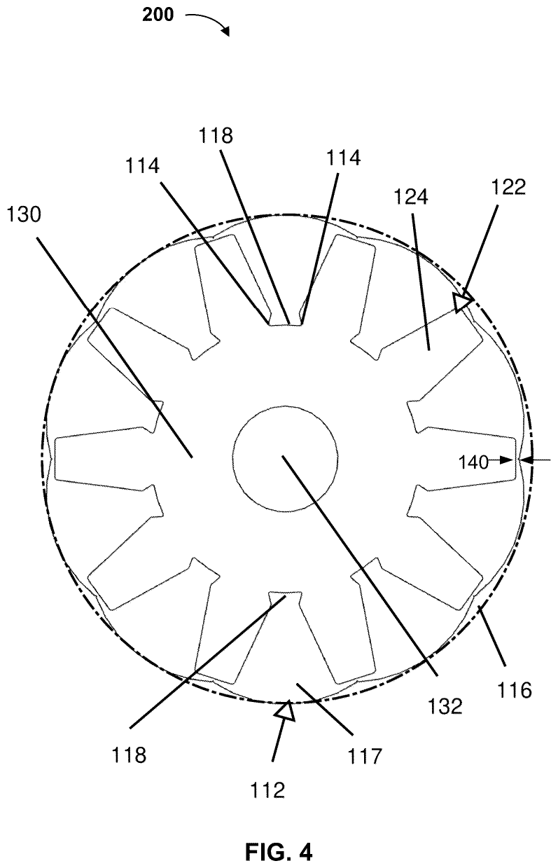

FIG. 4 is a side elevation view of a second embodiment of a molded internal permanent magnet rotor 200 for an EC motor in accordance with the disclosed technology. Certain features of the rotor 200 may be like those depicted in FIGS. 1-3 except that there may be no defined outer gaps between the outer ends 117 of the laminate sections 112. For example, the outer ends 117 of the laminate sections 112 may be contiguous to create a continuous steel laminate around the circumference 116 of the molded rotor 110. In this respect, the outer ends 117 of the laminate sections 112 may be connected to simplify manufacturing of the molded internal permanent magnet rotor 200, for example, so that individual mounting, aligning, and securing of the laminate sections 112 in the proper position may be aided by the outer connection between the laminate sections 112.

In certain implementations, the radial thickness 140 of the portions of the outer ends 117 of the laminate sections 112 near the ends of the radial extending portions 124 of internal permanent magnet molded rotor 200 may be reduced do minimize interference of the corresponding magnetic fields. In certain implementations, the outer ends 117 of the laminate sections 112 may be shaped to provide certain efficiency and/or noise reduction, as will be discussed further below with reference to FIGS. 6-8.

Apart from the continuous steel laminate around its circumference 116, the second embodiment of the molded internal permanent magnet rotor 200 may include certain similar features as discussed above with reference to the rotor 100 illustrated in FIGS. 1-3. For example, the second embodiment of the molded internal permanent magnet rotor 200 includes laminate sections 112 having outer ends 117 and inner ends 118. The outer ends 117 may roughly define a circumference 116 for the molded rotor 110. The continuous steel laminate around the circumference 116 of the molded rotor 110 may define the outer ends 117 of the radial extending portions 124 of the internal permanent magnet molded rotor 200. In this implementation, a plurality of wedge-shaped silicon steel laminate sections 112 may be disposed circumferentially around the molded rotor 200 and injection molded with magnetic plastic material 122. The molded magnetic plastic material 122 may be injected between the laminate sections 112 to form radially extending portions 124 disposed between the laminate sections 112. The radial extending portions 124 may further extend inwardly to form an internal ring portion 130. The internal ring portion 130 may include an opening 132 to accommodate a shaft for rotation of the molded rotor 200.

With continuing reference to FIG. 4, and in accordance with certain exemplary implementations of the disclosed technology, each of the inner ends 118 of the wedge-shaped laminate sections 112 can include retaining features 114 (such as dovetail shapes) extending circumferentially from the inner ends 118 into the magnetic plastic material 122. Once the magnetic plastic material 122 of the molded rotor 200 has cured and hardened, the magnetic plastic material 122 may interlock and secure the laminate sections 112 to the rotor 200 without the need for any external wrapping or retainer. As with the previously described embodiment, suitable magnetic plastic material 122 can include materials shown in Table 1.

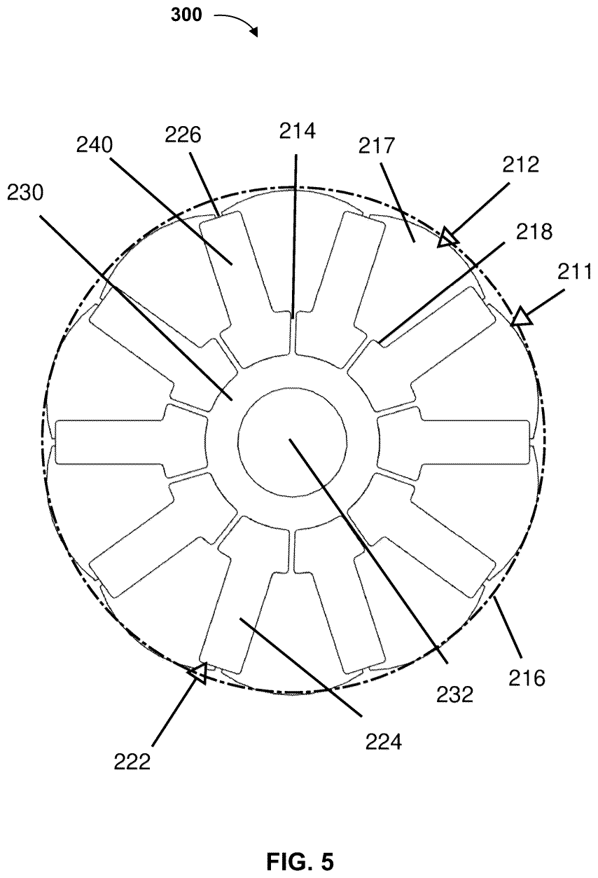

FIG. 5 depicts a side elevation view of a third embodiment of a molded internal permanent magnet rotor 300 for an EC motor in accordance with the disclosed technology. In this embodiment, a laminate skeleton 211 can include laminate sections 212 connected by a steel neck 214 to an internal steel ring 230 with an opening 232 to accommodate a shaft. In certain implementations, the laminate sections 212, the steel neck 214, and the internal steel ring 230 may define voids 240 into which magnetic plastic material 222 may be injection molded. As such, the magnetic plastic material 222 may be retained in the voids 240, thereby eliminating the need for a wrap around the circumference of the molded rotor. In certain implementations, the laminate sections 212 may be circumferentially disposed around the molded rotor 300. The laminate sections 212 may define outer ends 217 and inner ends 218. The outer ends 217 may roughly define a circumference 216 for the molded rotor 300. In certain implementations, the outer ends 217 of the laminate sections 212 may be separated from each other by gaps 226. In certain implementations, the inner ends 218 may terminate in the necks 214.

As previously stated, the magnetic plastic material 222 may be injected into the voids 240 to form the radially extending portions 224. The radially extending portions 224 may be disposed between the laminate sections 212. The radially extending portions 224 are thus trapped within the voids 240 of the laminate skeleton 211. Consequently, no outer wrapping is required to maintain the magnetic material and the steel laminate material in place. As with the previously described embodiments, suitable magnetic plastic material 222 can include the materials shown in Table 1.

FIG. 6A is a side elevation view of a fourth embodiment of a molded internal permanent magnet rotor 400 for an EC motor in accordance with the disclosed technology. Inset illustrations of the injection molded rotor array 601 and one of the laminate sections 607 are shown for clarity. Certain features of the fourth embodiment of the rotor 400 may be similar to the previously described embodiments, but with a few notable example differences. For example, in this fourth embodiment of the injection molded internal permanent magnet rotor array 601 can include lobe-shaped outer regions 602 joined to an inner ring region 604, each of which may be made by injection molding the magnetic plastic material between the laminate sections 607. In certain implementations, a central opening 606 in the internal ring 604 may accommodate a shaft for rotation of the molded rotor 400.

As illustrated in FIG. 6A, the inner ends of the laminate sections 607 may include bulbous circular shaped retaining features 610 that have a diameter D that is greater than the immediately adjacent neck width W of the laminate sections 607. Therefore, in this example implementation, the retaining features 610 may extend circumferentially from the inner ends of the laminate sections 607 such that at least a portion of the retaining features 610 extend into the magnetic plastic material. Once the injected magnetic plastic material has cured and hardened, the magnetic plastic material may retain the laminate sections 607 without the need for any external wrapping or additional retainer.

As illustrated in FIG. 6A, and according to certain implementations, the retaining features 610 can include through holes 612 (characterized by a diameter d that is less than outer diameter D of the of retaining features 610) approximately centered in the retaining features 610. In accordance with certain exemplary implementations, the through holes 612 may be utilized to (temporarily) receive positioning rods therethrough to aid in aligning and/or securing the laminate sections 607 in the proper position during injection molding of the magnetic plastic material. For example, an injection molding fixture (not shown) having vertical positioning rods disposed in a circular arrangement about the central axis 614 (and co-axial with the illustrated positions of the through holes 612) may be utilized to receive the corresponding laminate sections 607 where the positioning rods extend through the through holes 612 to position and retain at least the inner portions of the laminate sections 607 during injection molding of the outer regions 602 and inner ring region 604. In certain implementations, the injection molding fixture may include additional alignment features for properly positioning and securing the outer ends of the laminate sections 607 during injection molding. In accordance with certain exemplary implementations of the disclosed technology, once the injection molding process has been completed and the injected magnetic plastic material has cured and hardened, the entire structure of the rotor 400 may be removed from the fixture, leaving the through holes 612. In some implementations, the through holes 612 may then be backfilled, for example, using magnetic or non-magnetic plastic material. In some implementations, the through holes 612 may be backfilled using a metal or other material. In certain implementations, material may be selectively added to the through holes 612 to help balance the weight of the rotor 400. In yet other implementations, the through holes 612 may remain empty after the injection molding process.

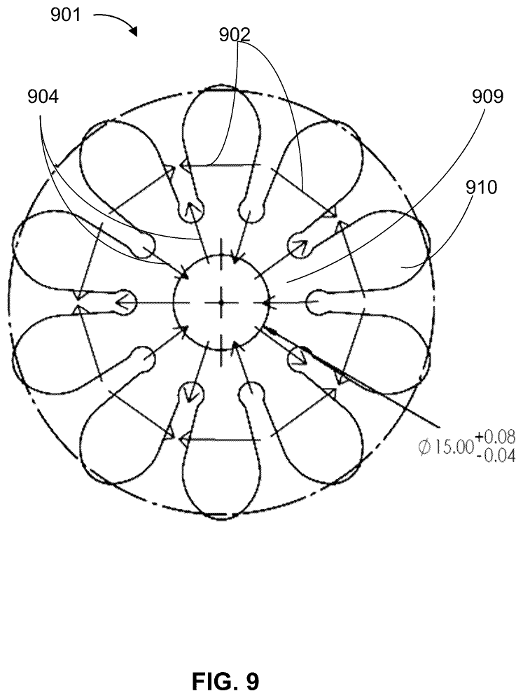

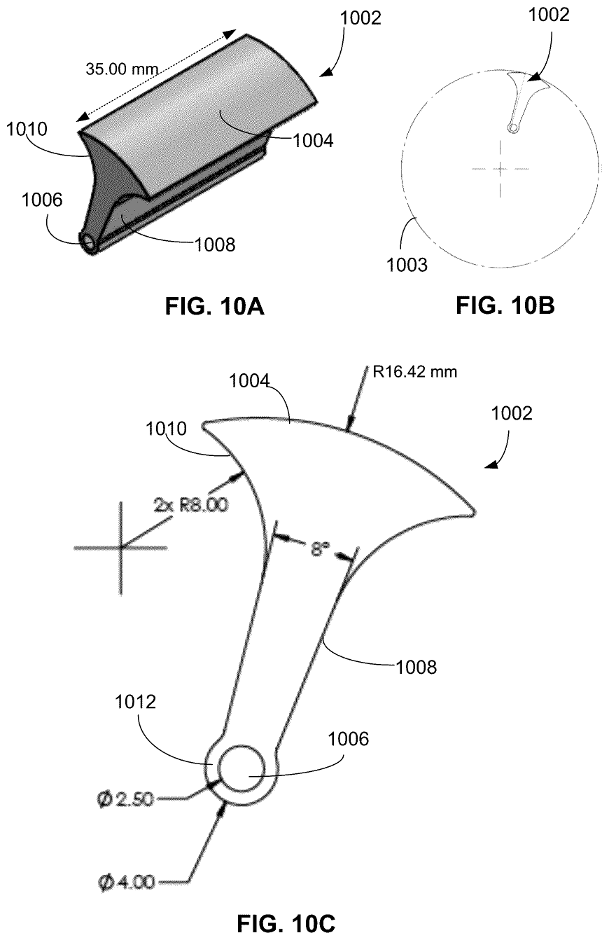

In accordance with certain exemplary implementations of the disclosed technology, the laminate sections 607 of the rotor 400 may be shaped 617 as shown (or approximately as shown) in FIG. 6A (and will be further discussed below with reference to FIGS. 10A and 10B). In certain implementations, the lobe-shaped outer regions 602 of the magnetic plastic material may form gaps 616 between outer edges of the laminate sections 607. In certain implementations, the gaps 616 may improve the magnetic field interaction of the rotor 400 with a corresponding stator without interference that could result if the outer edges of the laminate sections 607 were touching.

FIG. 6B is a side elevation view of a fifth embodiment of a molded internal permanent magnet rotor 500 for an EC motor in accordance with the disclosed technology. Inset illustrations of the injection molded rotor array 601 and one of the harmonically tuned laminate sections 608 are shown for clarity. Certain features of the fourth embodiment of the rotor 500 may be similar to the previously described embodiments. For example, in this fifth embodiment of the injection molded internal permanent magnet rotor array 601 can include lobe-shaped outer regions 602 joined to an inner ring region 604, each of which may be made by injection molding the magnetic plastic material between the laminate sections 608. In certain implementations, a central opening 606 in the internal ring 604 may accommodate a shaft for rotation of the molded rotor 400.

As illustrated in FIG. 6B, the inner ends of the laminate sections 608 may include bulbous circular shaped retaining features 610 that have a diameter D that is greater than the immediately adjacent neck width W of the laminate sections 608. Therefore, in this example implementation, the retaining features 610 may extend circumferentially from the inner ends of the laminate sections 608 such that at least a portion of the retaining features 610 extend into the magnetic plastic material. Once the injected magnetic plastic material has cured and hardened, the magnetic plastic material may retain the laminate sections 608 without the need for any external wrapping or additional retainer.

As illustrated in FIG. 6B, and according to certain implementations, the retaining features 610 can include through holes 612 (characterized by a diameter d that is less than outer diameter D of the of retaining features 610) approximately centered in the retaining features 610. In accordance with certain exemplary implementations, the through holes 612 may be utilized to (temporarily) receive positioning rods therethrough to aid in aligning and/or securing the laminate sections 608 in the proper position during injection molding of the magnetic plastic material. For example, an injection molding fixture (not shown) having vertical positioning rods disposed in a circular arrangement about the central axis 614 (and co-axial with the illustrated positions of the through holes 612) may be utilized to receive the corresponding laminate sections 608 where the positioning rods extend through the through holes 612 to position and retain at least the inner portions of the laminate sections 608 during injection molding of the outer regions 602 and inner ring region 604. In certain implementations, the injection molding fixture may include additional alignment features for properly positioning and securing the outer ends of the laminate sections 608 during injection molding. In accordance with certain exemplary implementations of the disclosed technology, once the injection molding process has been completed and the injected magnetic plastic material has cured and hardened, the entire structure of the rotor 500 may be removed from the fixture, leaving the through holes 612. In some implementations, the through holes 612 may then be backfilled, for example, using magnetic or non-magnetic plastic material. In some implementations, the through holes 612 may be backfilled using a metal or other material. In certain implementations, material may be selectively added to the through holes 612 to help balance the weight of the rotor 500. In yet other implementations, the through holes 612 may remain empty after the injection molding process.

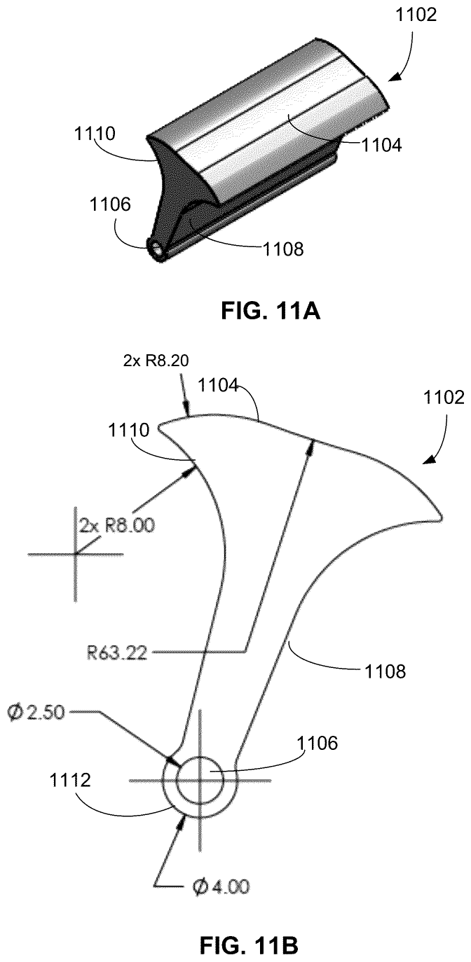

In accordance with certain exemplary implementations of the disclosed technology, the laminate sections 608 of the rotor 500 may be configured with a with a harmonic control shape 618 as shown (or approximately as shown) in FIG. 6B (and will be further discussed below with reference to FIGS. 11A and 11B). In certain implementations, the lobe-shaped outer regions 602 of the magnetic plastic material may form gaps 616 between outer edges of the laminate sections 608. In certain implementations, the gaps 616 may improve the magnetic field interaction of the rotor 500 with a corresponding stator without interference that could result if the outer edges of the laminate sections 608 were touching.

As illustrated in FIG. 6B, and in accordance with certain exemplary implementations of the disclosed technology, the outer regions of the laminate sections 608 may be configured with a harmonic control shape 618 to inject, suppress, or otherwise control certain natural frequency harmonics associated with the rotor 500 and/or its corresponding stator, for example, to improve torque and/or to make the corresponding motor quieter during operation. In this respect, the disclosed technology may provide certain benefits over traditional harmonic control techniques, which are typically implemented by shaping the permanent magnet rather than imparting the harmonic control shape 618 to the laminate sections 608 as provided herein. In certain implementations, the harmonic control shape 618 of the laminate sections 608 may be formed during a stamping process during manufacturing. In accordance with certain implementations of the disclosed technology, the harmonic control shape 618 may be devised to control a third, fifth, and/or seventh harmonic and/or sub-harmonic of the natural frequency of the associated motor. In accordance with certain exemplary implementations of the disclosed technology, other harmonics and/or sub-harmonics may be controlled using the harmonic control shape of the laminate sections 608.

FIG. 7A is a perspective view of a sixth embodiment of a molded internal permanent magnet rotor 600 for an EC motor having one or more axial magnet Halbach array end plates 702, in accordance with the disclosed technology. In accordance with certain exemplary implementations of the disclosed technology, areas of the one or more Halbach array end plates 702 may be selectively magnetized to help contain and concentrate the magnetic fields within the rotor 600. Further explanation of the Hallback array will be discussed below with reference to FIG. 7D. In accordance with certain exemplary implementations of the disclosed technology, the one or more Halbach array end plates 702 may be mounted to either end face of the rotor 600, as illustrated, and centered about a central rotational axis 704 of the rotor 600. Certain implementations of the molded internal permanent magnet rotor 600 may utilize just one Halbach array end plate 702, for example, to reduce cost.

In certain implementations, the one or more Halbach array end plates 702 may be manufactured and/or magnetized separately from the rest of the rotor 600. However, in other implementations, the one or more Halbach array end plates 702 may be manufactured (i.e., formed by injection molding) using the same magnetic plastic material as is used in the injection molded rotor array and while the regions of the injection molded rotor array of the rotor 600 are injection molded and magnetized in-situ. In implementations where the Halbach array endplate 702 is also formed by injection molding in the same fixture, through holes 706 may be formed co-axial with the through holes of the laminate sections (such as through holes 612 illustrated and discussed with respect to FIG. 6A and/or FIG. 6B), for example, by vertical positioning rods as discussed above to position and retain at least the inner portions of the laminate sections during injection molding (of the outer regions 602 and inner ring region 604, as illustrated in FIG. 6A). In certain implementations, the through holes 706 may be utilized to attach or further secure the Halbach array end plate 702 to the face of the rotor 600, for example, by using fasteners or screws that can be either metallic or non-metallic.

FIG. 7B is another perspective view of the sixth embodiment of a molded internal permanent magnet rotor 600 for an EC motor having one or more Halbach array end plate 702, in accordance with the disclosed technology. FIG. 7B more clearly shows the end plates 702 and the exposed ends of the outer regions 710 of the magnetic plastic material of the injection molded rotor array, which as discussed above, may be made from the same magnetic plastic material. Also illustrated for reference is the outer exposed portions of the laminate sections 708.

FIG. 7C is a perspective view of the sixth embodiment of a molded internal permanent magnet rotor 600 for an EC motor with one Halbach array end plate and the molded rotor portions shown transparently for clarity.

FIG. 7D is a side elevation example view of the sixth embodiment of a molded internal permanent magnet rotor 600 for an EC motor in accordance with the disclosed technology. FIG. 7D illustrates the radial position of the Halbach array end plate 702 relative to the injection molded magnetic rotor array 701 which has lobe-shaped outer regions 710 joined to the inner ring region 709, each of which may be made by injection molding the magnetic plastic material between the laminate sections 708. It should be appreciated that HG 7D is illustrated with a partially transparent Halbach array end plate 702 to show its positioning relative to associated components and centered about a central rotational axis 704. However, please refer to the illustrations of FIGS. 7A and 7B which show that the end plate 702 may be mounted to either end face of the rotor.

FIG. 7D further illustrates magnetic field lines and directions associated with the Halbach array end plate 702, which may also match up with corresponding field lines of a magnetized injection molded magnetic rotor array 701. For example, the arrow tips 712 represent north poles coming out of the page normal to the face of the Halbach array end plate 702, and arrow ends 714 going into the page. The corresponding (transverse) magnetic field line directions 716 718 are illustrated following the conventional directions of starting at north poles 712 and ending at south poles 714. The “N” 720 corresponds to the north magnetic field coming out of the lamination segments 708. In certain implementations, the Halbach array end plate 702 may contain the magnetic field to the lamination segments 708 so that the field extension is limited on the axial faces of the rotor 600 that are not in contact with the laminations.

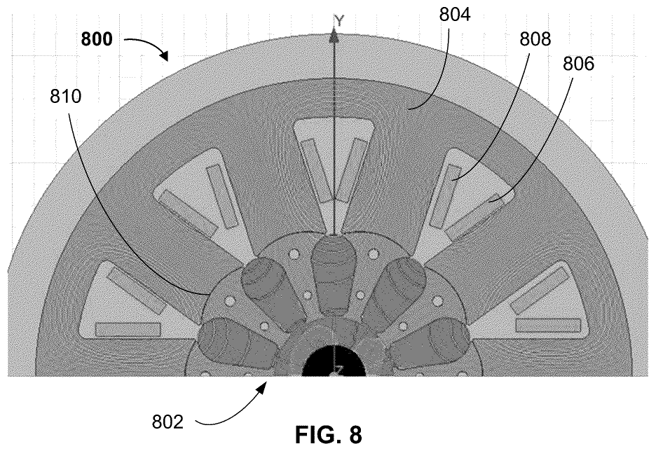

FIG. 8 is a partial side elevation view of an example in-situ magnetizing apparatus 800, in accordance with certain implementations of the disclosed technology, in which an example injection molded internal permanent magnet rotor assembly 802 for an EC motor may be inserted into a central section of a spoked laminate section 804 of the magnetizing apparatus 800. In certain implementations, electromagnets 806 808 may be energized to set up strong magnetic fields in the spoked laminate section 804, which may have ends 810 shaped for intimate connection with corresponding laminate sections of the rotor assembly 802, thereby transferring the externally generated magnetic fields to the corresponding laminate sections of the rotor assembly 802 and magnetizing the injection molded rotor array.

In certain implementations, the magnetizing apparatus 800 may include a pulse power supply unit that may include one or more power capacitors along with a charge and discharge unit. In certain implementations, the capacitors may be selectively discharged to send high currents to the electromagnets 806, 808 to feed energy to the magnetizing apparatus 800 to magnetize the injection molded internal permanent magnet rotor assembly 802. In certain implementations, one or more associated Halbach array end plates may be selectively magnetized at the same time as the rotor assembly 802 is magnetized. Depending upon the electrical conductivity of both magnet materials and surrounding assembly parts, either low capacitance, high voltage configuration or vice versa, high capacitance and low voltage combination may be needed for proper magnetization avoiding eddy current effects. In certain implementations, the magnetizing apparatus 800 design may be affected by factors such as number of poles in the rotor, rotor skew, rotor shape, rotor height, magnet material, space availability, desired particular field along a specified path or surface, etc.

FIG. 9 is a side elevation view of a magnetized injection molded internal permanent magnet rotor array 901, where the arrows indicate the magnetic field direction of the injection molded permanent magnet rotor array 901 only, in accordance with certain exemplary implementations of the disclosed technology. For example, opposing circumferential magnetic fields 902 are illustrated in the lobe-shaped outer regions 910, and alternating radially extending magnetic fields 904 are illustrated in the inner ring portion 909 of the magnetized injection molded internal permanent magnet rotor array 901.

FIG. 10A is a perspective view of an example laminate section 1002 implementation, in accordance with the disclosed technology. This example laminate section 1002 implementation may be the same or similar as the laminate sections 607, as discussed above and illustrated in FIG. 6A. In certain implementations, the laminate section 1002 may be made from multilayer silicon steel, for example, to help increase the magnetic flux strength while reducing eddy currents. In accordance with certain exemplary implementations of the disclosed technology, the example laminate section 1002 may be characterized by having a radiused outer face 1004, a through hole 1006 (which may be the same as the through hole 612 as discussed above with reference to FIG. 6A) extending through the length of the laminate section 1002, a neck portion 1008, and radiused outer neck portions 1010. As illustrated, the example laminate section 1002 may have a transverse length (parallel with the axis of rotation) of about 35 mm, however, many different lengths may be utilized depending on the desired size of the rotor. In accordance with certain exemplary implementations of the disclosed technology, the shape and placement of the laminate sections 1002 may define a void for which injection molded internal permanent magnet rotor (such as the injection molded rotor array 601 illustrated in FIG. 6A) may be defined.

FIG. 10B is a side elevation view of one example laminate section 1002 disposed relative to the outer axial circumference 1003 of the rotor. It should be understood that a plurality of additional laminate sections 1002 may be selectively disposed around the circumference 1003, as shown in FIG. 6A.

FIG. 10C is a side elevation view of the example laminate section 1002 embodiment as illustrated in FIGS. 10A and 10B in accordance with the disclosed technology. In this example implementation, the outer face 1004 may be characterized by a radius of about 16.5 mm. However, different radius values may be utilized depending on the desired size of the rotor. In certain implementations, the radiused out neck portions 1010 may be characterized by a radius of about 8 mm. However, different outer neck radius values may be utilized depending on the desired size of the rotor. In certain implementations, and as illustrated, the through hole 1006 may be characterized as having a diameter of about 2.5 mm. However, different through hole diameter values may be utilized depending on the desired size of the rotor. In certain implementations, and as illustrated, the bulbous retaining feature 1012 surrounding the through hole 1006 may be characterized as having a diameter of about 4 mm. However, different retaining feature diameter values may be utilized depending on the desired size of the rotor. In certain implementations, the retaining feature 1012 may be similar or the same as the retaining features 610 as discussed above with reference to FIG. 6A.

FIG. 11A is a perspective view of an example laminate section 1102 implementation in accordance with the disclosed technology. This example laminate section 1002 implementation may be the same or similar as the laminate sections 608, as discussed above and illustrated in FIG. 6B, and/or laminate sections 708, as discussed above and illustrated in FIGS. 7A-D. In certain implementations, the laminate section 1102 may be made from multilayer silicon steel, for example, to help increase the magnetic flux strength while reducing eddy currents. In accordance with certain exemplary implementations of the disclosed technology, the example laminate section 1102 may be characterized by having a double radiused outer face 1104, a through hole 1106 extending through the length of the laminate section 1102, a neck portion 1108, and radiused outer neck portions 1110. The example laminate section 1002 may be made having a transverse length (parallel with the axis of rotation) set depending on the desired size of the rotor. In accordance with certain exemplary implementations of the disclosed technology, the shape and placement of the laminate sections 1102 may define a void for which injection molded internal permanent magnet rotor (such as the injection molded rotor array 701 illustrated in FIG. 7D) may be defined.

FIG. 11B is a side elevation view of the example laminate section embodiment as illustrated in FIG. 11A in accordance with the disclosed technology. In this example implementation, the outer face 1104 may be characterized by harmonic control shape having a double radius of about 8.2 mm. However, different radius values may be utilized depending on the desired size of the rotor and the nature of the harmonic control. In certain implementations, the radiused out neck portions 1110 may be characterized by a radius of about 8 mm. However, different outer neck radius values may be utilized depending on the desired size of the rotor. In certain implementations, and as illustrated, the through hole 1106 may be characterized as having a diameter of about 2.5 mm. However, different through hole diameter values may be utilized depending on the desired size of the rotor. In certain implementations, and as illustrated, the bulbous retaining feature 1112 surrounding the through hole 1106 may be characterized as having a diameter of about 4 mm. However, different retaining feature diameter values may be utilized depending on the desired size of the rotor. In certain implementations, the retaining feature 1112 may be similar or the same as the retaining features 610 as discussed above with reference to FIG. 6A.

As discussed above with reference to FIG. 6B, the harmonic control shape of the outer face 1104 as shown in FIG. 11B may be implemented to inject, suppress, or otherwise control certain natural frequency harmonics associated with the rotor and/or its corresponding stator, for example, to improve torque and/or to make the corresponding motor quieter during operation. In this respect, the disclosed technology may provide certain benefits over traditional harmonic control techniques, which are typically implemented by shaping the permanent magnet rather than imparting the harmonic control shape to the laminate sections 1102 as provided herein. In certain implementations, the harmonic control shape of the laminate sections 1102 may be formed during a stamping process during manufacturing. In accordance with certain implementations of the disclosed technology, the harmonic control shape may be devised to control a third, fifth, and/or seventh harmonic and/or sub-harmonic of the natural frequency of the associated motor. In accordance with certain exemplary implementations of the disclosed technology, other harmonics and/or sub-harmonics may be controlled using the harmonic control shape of the laminate sections 1102.

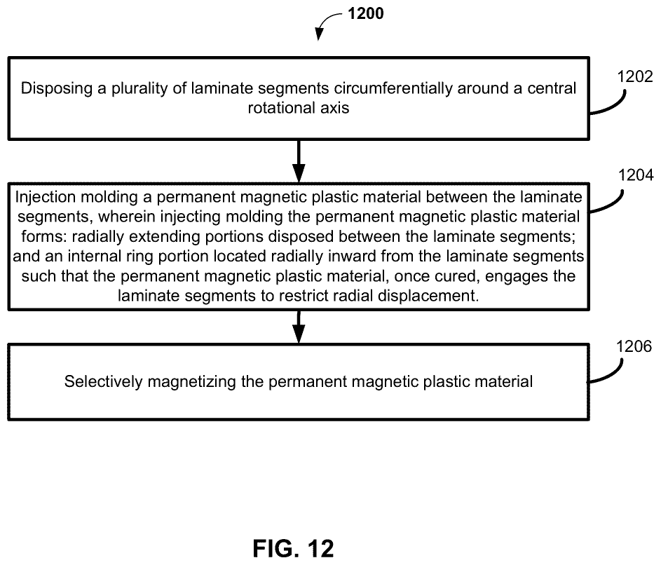

FIG. 12 is a flow diagram of a method 1200, in accordance with certain exemplary implementations of the disclosed technology. In block 1202, the method 1200 includes disposing a plurality of laminate sections circumferentially around a central rotational axis. In block 1204, the method 1200 includes injection molding a permanent magnetic plastic material between the laminate sections, wherein injecting molding the permanent magnetic plastic material forms: radially extending portions disposed between the laminate sections; and an internal ring portion located radially inward from the laminate sections such that the permanent magnetic plastic material, once cured, engages the laminate sections to restrict radial displacement. In block 1206, the method 1200 includes selectively magnetizing the permanent magnetic plastic material.

In certain implementations, each of the plurality of laminate sections can include a circumferentially extending retaining feature is configured to engage with cured injection molded permanent magnetic plastic material to secure the laminate sections in place.

In certain implementations, each of the circumferentially extending retaining features of the laminate sections may include a pin-retaining through hole. The pin-retaining through holes may be configured to secure the plurality of laminate sections around the central rotational axis with alignment pins disposed in each pin-retaining through hold during injection molding.

In certain implementations, injecting molding the permanent magnetic plastic material may include forming an opening centered on the central rotational axis for installation of a shaft.

In certain implementations, injection molding the permanent magnetic plastic material can include injection molding magnetic plastic material comprising one or more of ferrite and NdFeB magnetic plastics. In certain implementations, injection molding the permanent magnetic plastic material can include injection molding magnetic plastic material comprising one or more of the materials shown in Table 1.

Certain implementations of the disclosed technology can include forming predefined isolated voids between the laminate sections for injection of the magnetic plastic material into the voids. In accordance with certain exemplary implementations of the disclosed technology, the magnetic plastic material may fill the shape of the predefined voids.

Certain implementations can include disposing one or more radially extending end plates on or more corresponding transverse ends of the rotor. In certain implementations, the one or more radially extending end plates can include a Halbach array made from permanent magnet plastic material. In certain implementations, regions of the Halbach array may be selectively magnetized.

Certain implementations of the disclosed technology include configuring a shape of the plurality of laminate sections to control one or more of overtones, noise, and torque.

In accordance with certain implementations of the disclosed technology magnetization may be generally completed by an external magnetizer while the permanent magnet plastic material is curing. A magnetic field may be selectively applied to the permanent magnet plastic material. In accordance with certain exemplary implementations of the disclosed technology, the magnetizer may be configured based on the size of the permanent magnet plastic material to be magnetized, the magnetization direction, and the desired location and strength of the magnetizing field. In certain implementations, the magnetizing magnetic field may be set to approximately 3-5 times the coercive force of the magnet, which may be set by magnetization current. In certain implementations, the capacity of an energy storage capacitor to provide the magnetization current of the magnetizer may be determined according to the current and the voltage of the magnetizer.

In accordance with certain exemplary implementations of the disclosed technology, the rotor poles may be made by injection molded magnets made from particles of hard magnetic material. For example, injection molded magnets for the rotor poles may be made from dense magnetic powders blended with a variety of polymer base materials as a binder. Depending on the combination of magnetic material and polymer selected, a wide range of final material properties and complex shapes are possible. The injection molded magnets may form simple shapes to very complex shapes. Depending on the magnetic material, the parts may require magnetic orientation during the injection molding process to optimize the magnetic properties. In accordance with certain exemplary implementations of the disclosed technology, injection molded magnets can be utilized to define corresponding regions of poles in the rotors.

The disclosed technology can be further understood according to the following clauses:

Clause 1: A molded internal permanent magnet rotor, comprising: a plurality of laminate sections disposed circumferentially around the rotor: a permanent magnetic plastic material injection molded between the laminate sections, wherein the permanent magnetic plastic material forms: radially extending portions disposed between the laminate sections; and an internal ring portion located radially inward from the laminate sections, wherein the permanent magnetic plastic material, once cured, engages the laminate sections to restrict radial displacement.

Clause 2: The molded internal permanent magnet rotor of clause 1, wherein the laminate sections each include circumferentially extending retaining features that engage the cured magnetic plastic material to secure the laminate sections in place.

Clause 3: The molded internal permanent magnet rotor of clause 2, wherein each of the circumferentially extending retaining features of the laminate sections comprise a central through-hole for engagement with an alignment pin during injection molding.

Clause 4: The molded internal permanent magnet rotor of any one of the preceding clauses, wherein the laminate sections are silicon steel laminate sections.

Clause 5: The molded internal permanent magnet rotor of any one of the preceding clauses, wherein the laminate sections are configured with outer ends separated by gaps, and the magnetic plastic material at least partially fills the gaps between adjacent laminate sections.

Clause 6: The molded internal permanent magnet rotor of one of the preceding clauses, wherein the internal ring portion of the permanent magnetic plastic material defines an opening for installation of a shaft.

Clause 7: The molded internal permanent magnet rotor of one of the preceding clauses, wherein the magnetic plastic material is selected from materials including one or more of ferrite and NdFeB magnetic plastics.

Clause 8: The molded internal permanent magnet rotor of one of the preceding clauses, wherein the laminate sections are configured to form predefined voids between the laminate sections for injection of the magnetic plastic material into the voids, wherein the magnetic plastic material fills a shape of the predefined voids.

Clause 9: The molded internal permanent magnet rotor of one of the preceding clauses, further comprising one or more radially extending end plates disposed on or more corresponding transverse ends of the rotor.

Clause 10: The molded internal permanent magnet rotor of clause 9, wherein the one or more radially extending end plates comprise a Halbach array made from permanent magnet plastic material.

Clause 11: The molded internal permanent magnet rotor of one of the preceding clauses, wherein the rotor is configured for use in an electronically commutated DC motor.

Clause 12: A method of manufacturing a molded internal permanent magnet rotor, comprising: disposing a plurality of laminate sections circumferentially around a central rotational axis; injection molding a permanent magnetic plastic material between the laminate sections, wherein injecting molding the permanent magnetic plastic material forms: radially extending portions disposed between the laminate sections; and an internal ring portion located radially inward from the laminate sections; and selectively magnetizing the permanent magnetic plastic material, wherein the permanent magnetic plastic material, once cured, engages the laminate sections to restrict radial displacement.

Clause 13: The method of clause 12, wherein each of the plurality of laminate sections include a circumferentially extending retaining feature that engages with cured injection molded permanent magnetic plastic material to secure the laminate sections in place.

Clause 14: The method of clause 13, wherein each of the circumferentially extending retaining features of the laminate sections comprise a pin-retaining through hole.

Clause 15: The method of any one of clauses 12 to 14, further comprising securing the plurality of laminate sections around the central rotational axis with alignment pins disposed in each pin-retaining through hole during injection molding.

Clause 16: The method of any one of clauses 12 to 15, wherein injecting molding the permanent magnetic plastic material further forms an opening centered on the central rotational axis for installation of a shaft.

Clause 17: The method of any one of clauses 12 to 16, wherein injection molding the permanent magnetic plastic material comprises injection molding magnetic plastic material comprising one or more of ferrite and NdFeB magnetic plastics.

Clause 18: The method of any one of clauses 12 to 17, further comprising forming predefined isolated voids between the laminate sections for injection of the magnetic plastic material into the voids, wherein the magnetic plastic material fills a shape of the predefined voids.

Clause 19: The method of any one of clauses 12 to 18, further comprising disposing one or more radially extending end plates on or more corresponding transverse ends of the rotor, wherein the one or more radially extending end plates comprise a Halbach array made from permanent magnet plastic material.

Clause 20: The method of any one of clauses 12 to 19, further comprising configuring a shape of the plurality of laminate sections to control one or more of harmonics and sub-harmonics.

It is to be understood that the embodiments and claims disclosed herein are not limited in their application to the details of construction and arrangement of the components set forth in the description and illustrated in the drawings. Rather, the description and the drawings provide examples of the embodiments envisioned. The embodiments and claims disclosed herein are further capable of other embodiments and of being practiced and carried out in various ways. Also, it is to be understood that the phraseology and terminology employed herein are for the purposes of description and should not be regarded as limiting the claims.

Accordingly, those skilled in the art will appreciate that the conception upon which the application and claims are based may be readily utilized as a basis for the design of other structures, methods, and systems for carrying out the several purposes of the embodiments and claims presented in this application. It is important, therefore, that the claims be regarded as including such equivalent constructions.

We claim:

1. A molded internal permanent magnet rotor, comprising:
a plurality of laminate sections disposed circumferentially around the rotor;
a permanent magnetic plastic material injection molded between the laminate sections, wherein the permanent magnetic plastic material forms:
radially extending portions disposed between the laminate sections; and
an internal ring portion located radially inward from the laminate sections;
wherein the permanent magnetic plastic material, once cured, engages the laminate sections to restrict radial displacement.

2. The molded internal permanent magnet rotor of claim 1, wherein the laminate sections each include circumferentially extending retaining features that engage the cured magnetic plastic material to secure the laminate sections in place.

3. The molded internal permanent magnet rotor of claim 2, wherein each of the circumferentially extending retaining features of the laminate sections comprise a central through-hole for engagement with an alignment pin during injection molding.

4. The molded internal permanent magnet rotor of claim 1, wherein the laminate sections are silicon steel laminate sections.

5. The molded internal permanent magnet rotor of claim 1, wherein the laminate sections are configured with outer ends separated by gaps, and the magnetic plastic material at least partially fills the gaps between adjacent laminate sections.

6. The molded internal permanent magnet rotor of claim 1, wherein the internal ring portion of the permanent magnetic plastic material defines an opening for installation of a shaft.

7. The molded internal permanent magnet rotor of claim 1, wherein the magnetic plastic material is selected from materials including one or more of ferrite and NdFeB magnetic plastics.

8. The molded internal permanent magnet rotor of claim 1, wherein the laminate sections are configured to form predefined voids between the laminate sections for injection of the magnetic plastic material into the voids, wherein the magnetic plastic material fills a shape of the predefined voids.

9. The molded internal permanent magnet rotor of claim 1, further comprising one or more radially extending end plates disposed on or more corresponding transverse ends of the rotor.

10. The molded internal permanent magnet rotor of claim 9, wherein the one or more radially extending end plates comprise a Halbach array made from permanent magnet plastic material.

11. The molded internal permanent magnet rotor of claim 1, wherein the rotor is configured for use in an electronically commutated DC motor.

12. A method of manufacturing a molded internal permanent magnet rotor, comprising:
disposing a plurality of laminate sections circumferentially around a central rotational axis;
injection molding a permanent magnetic plastic material between the laminate sections, wherein injecting molding the permanent magnetic plastic material forms:
radially extending portions disposed between the laminate sections; and
an internal ring portion located radially inward from the laminate sections; and
selectively magnetizing the permanent magnetic plastic material, wherein the permanent magnetic plastic material, once cured, engages the laminate sections to restrict radial displacement.

13. The method of claim 12, wherein each of the plurality of laminate sections include a circumferentially extending retaining feature that engages with cured injection molded permanent magnetic plastic material to secure the laminate sections in place.

14. The method of claim 13, wherein each of the circumferentially extending retaining features of the laminate sections comprise a pin-retaining through hole.

15. The method of claim 14, further comprising securing the plurality of laminate sections around the central rotational axis with alignment pins disposed in each pin-retaining through hole during injection molding.

16. The method of claim 12, wherein injecting molding the permanent magnetic plastic material further forms an opening centered on the central rotational axis for installation of a shaft.

17. The method of claim 12, wherein injection molding the permanent magnetic plastic material comprises injection molding magnetic plastic material comprising one or more of ferrite and NdFeB magnetic plastics.

18. The method of claim 12, further comprising forming predefined isolated voids between the laminate sections for injection of the magnetic plastic material into the voids, wherein the magnetic plastic material fills a shape of the predefined voids.

19. The method of claim 12, further comprising disposing one or more radially extending end plates on or more corresponding transverse ends of the rotor, wherein the one or more radially extending end plates comprise a Halbach array made from permanent magnet plastic material.

20. The method of claim 12, further comprising configuring a shape of the plurality of laminate sections to control one or more of harmonics and sub-harmonics.
